(19) United States
(12) Patent Application Publication
(10) Pub. No.: US 2004/0206248 A1
(43) Pub. Date: Oct. 21, 2004

(54) Browning control

(76) Inventor: Anthony Charles Lawson, Phuket (TH)

Correspondence Address: Edwin D Schindler, Five Hirsch Avenue, PO Box 966, Coram, NY, 11727-0966, US

(21) Appl. No.: 10/485,885

(22) PCT Filed: Aug. 1, 2002
(86) PCT No.: PCT/AU02/01013

(30) Foreign Application Priority Data
Aug. 1, 2001 (AU) PR 6758

(51) Int. Cl. A47J 37/08

(52) U.S. Cl. 99/388

(57) ABSTRACT

A browning control specifically for use with toasters but which can also be used in other applications such as ovens in which the original colour of the item (20) to be browned is ascertained, the required colour for the article (20) is selected by a user and the change of colour of the article is monitored (50, 51, 52) until it reaches the required colour at which time the article (20) is ejected or the power courting the browning is removed.

### TECHNICAL AREA

This invention relates to improvements in the method of automatically controlling the degree of browning of a variety of bread types in electric toasters, and of bread, cakes and other foodstuffs in electric ovens.

The application in which browning control is most required, is in the control of toasters and the control of the degree of browning of bread in a multiple-slot toaster, will be used as an exemplification of the invention, without limitation to other applications.

In this specification, the word “photocell” is used as a generic for any light-sensing device; “illuminator” for a source of light compatible with the photocell, and “optical system” is used to describe the combination of a photocell, or photocells, and an illuminator. “Bread” is used as a generic for food items normally cooked in an electric toaster, such as sliced bread, muffins, hamburger buns and the like. The word “colour”, in certain instances, may refer to the monochromatic density, or grey scale factor, of the bread's surface, rather than to a specific chromatic tone.

### BACKGROUND

In modern pop-up toasters, the most widely used method of cooking control is to pre-set the length of the cooking time using an electronic timer. Proposals have also been made for methods that monitor the change in colour of the bread's surface, as it becomes cooked. Some propose a single photocell used in conjunction with a balancing potentiometer, or set of pre-set resistances to control the degree of browning, while at least one proposes the use of two photocells: one monitoring the continuously darkening bread, while the other monitors a colour scale which the user can pre-set to a desired colour. The photocells use electronic circuits to detect when a matching condition is reached.

Darkening Surfaces: A grey scale with ten divisions, from white to apparent black, may be used to simulate the stages of white bread becoming darker. When measured with a fixed-position photographic spot-meter, under constant lighting conditions, each division represents a comparative reflective differential of approximately one-tenth of a photographic stop, and such measurements can form the theoretical basis for a browning control. However, the conditions that exist within a working toaster are far from those that prevail on a test bench, and a practical working system should be able to take a number of variables into account. The most important of these are listed below.

The thickness of the bread being toasted—from 6 mm to over 25 mm

The starting condition of the bread—room temperature, cold or frozen

The starting colour of the bread—from white to dark brown

The state of the optical system—toasters produce a lot of dust

The age of the illuminator(s)

The ambient lighting conditions where the toaster is situated

The changes in temperature around the sensor(s) and electronic circuitry

Bread Thickness. This is one of the most serious problems, because the position of the surface of the bread being monitored, in relation to the illuminator and photocell, is critical.

For example, assuming that the illuminator and photocell are equidistant from the bread to be toasted, an average distance from bread's surface to optical system must be selected as a basis for calculating the steadily decreasing light falling on the photocell. Assuming a bread thickness range of 6 mm to 20 mm (although some modern toasters are able to accommodate much thicker items), it would seem reasonable to set the electronic circuitry to give optimum results for a bread thickness of 14 mm. Therefore, assuming that the toaster is fitted with an accurate self-centring device, for each 2 mm variation in bread thickness, the distance from the optical system will either increase or decrease by 1 mm, when thicker or thinner than average bread slices are to be toasted.

However, the light has to travel double this distance—from the illuminator to the bread and back to the photocell—therefore, for each 1 mm decrease in bread thickness, the increased distance that the light must travel is also 1 mm, and the converse is true as the bread thickness increases.

Within the confines of an average toaster's shell, the distance between the bread surface and the optical system cannot be much greater than 30 mm, and, given the effect of the inverse square law, such differences become significant.

Unless an automatic adjustment device is included, in the case of a thicker than average slice, the bread's surface will appear to be much brighter to the photocell, and the circuitry will not react until it is a lot darker than the comparative increment selected by the user is balanced. Such a discrepancy may be anything up 3/10ths of a photographic stop. So, if the user expected a medium brown (the setting for an average slice), a thick slice would be burnt.

In the case of a thinner than average slice, the bread's surface will appear to be darker to the photocell, at the beginning of the cooking cycle, and the cooking sequence would be terminated after only the slightest change in the bread's colour has been detected. These are the extremes, but even slight variations in thickness—from the average—will cause annoying differences in the results that were expected by the user.

Frozen Bread: Bread that is very cold or frozen is often bent out of shape, and it can take a minute or so to straighten out, as it thaws. This will also cause the distance from the surface being monitored to vary, in relation to the optical system, until the thawing phase is complete.

Brown Colour: Bread that is already brown can present a problem in systems that rely on the user's colour judgement. For example, a particular shade of brown bread may appear lighter to the eye than a user-selected reference colour, but may, in fact, reflect less light.

Dust: In a single-photocell system, the build up of dust on the illuminator and the photocell will cause worsening operational discrepancies over a period of time. In a dual-photocell system, the effect of dust will be self-cancelling, but only to a certain extent.

Deterioration of the Illuminator: In a single-photocell system, any deterioration in light is output will affect the system's efficiency. In a dual-cell system, the fall off in illumination will be self-balancing.

Ambient Light: Both the single- and dual-photocell systems rely on a relatively fixed illumination of the darkening bread. Should the ambient light conditions vary, say by the toaster being placed under a bright light, so that the surface of the bread being monitored receives additional illumination, neither system would function correctly.

Ambient Temperature: The rise in temperature of the circuitry, during successive toasting cycles may affect such a sensitive system.

Given the above, it is not surprising that there appear to have been no commercially satisfactory systems that utilise the darkening of the material being cooked to determine when the cooking cycle should be automatically terminated.

### OUTLINE OF THE PRESENT INVENTION

The principal object of the invention is to provide an optical-colour control system where the above-mentioned variables are automatically balanced out, neutralised, or otherwise taken into account before toasting begins, as well as during the cooking period, when the food to be cooked changes colour, so that the results will be in accordance with the user's expectations.

The invention includes an optical-colour control system for browning products being cooked including means whereby the initial colour of the product is ascertained, means to provide an indication of the required completion colour of the product, means to ascertain when the product reaches the completion colour and means to prevent further browning when this is reached.

The invention also provides a method of controlling the browning of a product by the use of the optical colour control system including the steps of detecting the greyscale of the product, obtaining a variable dependent on the greyscale to adapt the initial greyscale reading, selecting a required end colour of the product, causing the elements to heat the product and change the effective colour of the product, ascertaining the ongoing greyscale value of the product, and on the greyscale value reaching that representing the required end value, ceasing further heating of the product by the element.

Alternatively, several such optical systems may be utilised, so that an average of the darkening effect can be detected. The photocells and illuminators may be placed so as to “look” directly at the illuminated section of the bread, or light guides may be used so that the optical components can be placed in an area of the toaster that is relatively unaffected by temperature fluctuations.

In order that the invention may be more readily understood, I shall describe certain embodiments of the invention, as indicated earlier in relation to toasters, but with the proviso that the invention can have more general applications.

The toasters incorporating the invention may generally conform to the configurations used in existing systems. In the case of a bread toaster, a self-lifting carriage will be used, whereby the bread to be toasted is lowered into slots by depressing a lever, so that a solenoid, or similar electro-mechanical device, holds the bread in the vicinity of the cooking elements until the toasting cycle is complete. However, other configurations and arrangements may be used.

Selecting the Desired Colour: Prior to depressing the bread carriage, the user selects the degree of browning that is required either by moving a control pointer to the colour desired, or by selecting a browning number that may be associated with a colour comparison chart, which may be attached to the toaster's exterior. The browning control may also be used to select an increment in colour density, rather than to select an actual colour.

There may be a continuously variable selector, with a pointer sweeping across a darkening colour graphic, or one having several steps, or graduations, each representing a desired end colour. In the case of incremental browning, depending on the user's preference, a piece of white bread may require from three to five increments; a slice of light brown bread between one and three; while a slice of very dark brown bread would probably require only one increment; that is, an amount of browning just sufficient to ensure that the surface of the bread becomes crisp.

User Interface: This may be in the form of a rotating control knob, a linear slider control, or a set of buttons, any of which would allow the user to select a pre-calculated amount of resistance, or other digitally encoded information, to be introduced into the system's controller, immediately prior to the commencement of the browning sequence, which is described hereinafter.

Thickness: In less expensive models, using my system, the control knob may have three arrows, or marks, for thin, medium & thick slices, obviating the necessity of including an automatic thickness adjustment, so that the control knob will be turned to a slightly darker colour for thinner slices, to compensate for the distance that the light must travel within the optical system. Alternatively, a separate control may be included with which the user would select the thickness of the bread that they normally use.

Defrost: It may be desirable to provide a “Defrost” setting, when frozen bread is to be toasted, and, when appropriate, the user may select this function.

Microcontroller: With such variables to be taken into account, and with the advances in, and ever decreasing costs of mass produced digital sequencing components, a pre-balancing concept would lend itself to being either fully or partially controlled by a digital or analogue microcontroller. Such a miniature computer would accept the outputs of several monitoring and control devices, incorporated within the structure of the toaster, such as, but not limited to:

A primary photocell, which may monitor the bread's surface, directly, or after the light has passed through a light guide.

A secondary photocell to directly and continuously monitor the output of the illuminator, so that any fluctuations in the intensity of the illuminator may be factored out.

A potentiometer, or a set of push buttons, or similar, which would allow the user to pre-select the desired end colour of the toast, or the required number of browning increments.

A device to monitor the position of the front rack of a bread self-centring mechanism, in order to determine the distance from the bread's surface to a fixed point relative to the optical system. Or an independent probe which would serve the same purpose. Either may utilise a rotary potentiometer, to measure the arc through which the pivot point of one of the racks, or the probe rotates, for continuous monitoring, or there may be fixed resistors on a slider switch, so that only a few positions would be monitored, corresponding, say, to thin, medium and thick slices of bread.

A device that mechanically switches the optical system between two conditions, for a controlled period of tim:

In one condition, the photocell will monitor only the light being reflected from the bread's surface.

In the alternative condition, the light from the illuminator will either pass through a light guide, or fall directly onto the surface of the photocell, while the reflected light from the bread will be masked.

A device to bring the bread's surface to a fixed point, relative to the optical system, for a controlled period of time.

A thermistor, thermocouple or similar temperature sensing device, or devices.

An additional photocell to monitor any ambient light that may affect the toaster's performance, by partially illuminating the bread.

A “fine tuning” control that would allow a small measure of adjustment, should a user feel that the results are not closely matching the colour that he or she sets prior to a toasting cycle.

Electronic Circuitry: It would be possible to incorporate many, if not all, of the above parameters into a conventional electronic circuit—using voltage dividers, transistors and at least one comparator integrated circuit—to detect a matching condition between light reflected from the bread's surface and a user selected “brownness” parameter, while compensating for such variables as the state of the illumination and the thickness of the bread. However, I prefer an alternative solution.

Method of Control: I propose the use a microcontroller to monitor the information produced by any or all of the above-mentioned devices, in order to accurately detect when the food is cooked to the user's preference.

Microcontroller Set Up: Certain parameters may be stored in the microcontroller's memory. For example, it may store a digital factor, I (Illumination), representing the condition when the light from the illuminator is directed at the primary photocell, and not reflected from any surface. It may also store a digital factor, W, for the thickest white bread that the toaster is able to accommodate, so that a comparison can be made with readings taken during each operating cycle. These factors will be factory pre-determined and pre-set, under ideal illumination and photocell conditions, so that any deterioration can be automatically factored into future operations.

The microcomputer will also store a digital factor, G (Gloom), that represents the low light conditions that will prevail when the toaster's controlled slot is empty.

Microcontroller Operating Cycle: When the bread carriage is depressed, the illuminator and the power supply to the microcontroller are switched on.

1. An initial reading is taken of the bread monitoring photocell's output, and, if it is over the pre-set figure, G, the cycle will be immediately terminated.

2. Assuming that there is bread in the controlled slot, after a timed delay, or several null cycles, to allow the electronics to settle (which may include the defrost delay), the monitoring devices will then be “read”. The following is a preferred order, but a different sequence may also achieve the desired result.

3. The user colour pre-set is read by the microcomputer and stored as C (Colour)

4. In order to ensure that any deterioration in the optical system may be taken into account, either of the following two methods, or a combination of both, may be employed.

a) In an embodiment of the invention where primary and secondary photocells are used, one cell will monitor the light being reflected from the bread's surface, while another (placed in the same vicinity and with the inclusion of some kind of light attenuator to bring its output into line with that of the primary photocell) will directly monitor the light from the illuminator. By comparing the readings from these two photocells, and the factory pre-sets, the microcomputer will be able to eliminate any errors brought about by changes in the illuminator's light output, producing a factor, F, which will represent only the colour density of the bread's surface, all other variables having been discounted.

b) In another embodiment, the light from the illuminator is first directed towards the primary photocell—through any light guide, or guides that may be in the illuminator's path—and this reading is memorised, as D (Direct). This reading is then compared with the factory pre-set illumination factor, I, and, or the benchmark factor, W, to produce a factor which takes the present condition of the optical system into account. The condition of the optical system is then altered, so that light now falls on the bread's surface, and a reflected light reading is taken by the photocell, and stored. Any combination of the above parameters may then be used to produce the above-mentioned factor, F.

5. At this point an auto reject sequence may be initiated, under either of the following conditions:

a) If the bread in the controlled slot is already darker than the user-selected colour choice

b) If the bread is so dark that cooking, or further cooking would not appreciably darken its surface before it began to burn

6. Presuming that neither condition (a), nor (b), above, prevail, the toasting cycle will continue. The thermistor, or thermocouple is read, giving T (Temperature), which is factored into any of the readings from devices or components that may be affected by a rise in temperature.

7. The device monitoring the position of the self-centring racks, or the distance probe, is read, giving a factor, TH (Thickness) which allows the microcomputer to determine the digital adjustment necessary for correct browning to be achieved for varying bread thicknesses, in accordance with the position of the user pre-set. In certain circumstances, a low reading, signalling that the slot is empty, could also cause a fail-safe, auto-reject sequence to be initiated. An alternative to detecting the position of the centring device is to mechanically bring the surface of the bread to a fixed position, close to the optical system, momentarily, and take a photocell reading. By comparing this reading with one taken when the bread is in its centred position, the distance that the bread has receded may be calculated, thereby giving its position in relation to the optical system. In either event, the present colour of the bread may now be calculated by the microcontroller, and a warning light may flash, should it be too dark for the prevailing user-controlled browning setting.

Continuous Monitoring: With the appropriate information either available to, or previously stored in the microcomputer, the various inputs can be re-monitored and a number of running calculations and adjustments may be automatically performed. For example: continual adjustments may be required to compensate for the rise in the photocells' inherent resistances, due to the inevitable rise in temperature; this change being quite independent of the change brought about by the darkening bread. Also, should the bread become distorted, as it gets hot, causing its surface to come closer to either heating element, this will be detected by the centring device monitor, or thickness probe. This factor can then be taken into account, if necessary. (An ambient light photocell may also be read.)

At this point in the cycle, all of the variables will have been taken into account by the programme embedded in the microcontroller, and the sequence will be repeated until a predetermined condition is met, or the user manually terminates the cycle.

Cycle Example: In this example, it is assumed that a decrease in light falling on the photocells will cause an increase in the voltage across their terminals, as is the case with a light dependant resistor (LDR). Therefore, as the bread becomes darker, the reading of the primary cell will increase: If the user has selected a medium brown colour, before toasting a slice of thin, white bread, with the appropriate automatic adjustment for the bread's thickness, a number, say, 2100 may be the “target” point where the cycle should be terminated. Having already made adjustments for the state of the optical system, the microcomputer has calculated a bread-monitoring factor, F, of, say, 1875. Therefore, an IF . . . THEN . . . ELSE sequence may be used to detect when the target condition exists, and in a basic computer language it would look something like:

IF FACTOR<TARGET THEN RECYCLE ELSE EJECT

“FACTOR” is a number variable representing the photocell's error-adjusted output; “TARGET” is a number variable which represents the user colour pre-set, auto-adjusted for bread thickness; “<” is a mathematical operator meaning “is less than”. RECYCLE loops the microcontroller's program back to an earlier point, from where it again monitors each of the appropriate parameters. Should FACTOR have increased in value So that it exceeds TARGET, ELSE directs the computer to branch to the alternative sequence named “EJECT”, which causes the power to the toaster's carriage solenoid to be cut off. In the above example, it may take about two minutes for the FACTOR figure to increase until it equals or exceeds the TARGET of 2100, at which point the toast will be ejected, and the microcontroller switched off.

If desired, the user could then adjust the colour control to a darker position, and immediately re-toast the bread to new, darker condition.

Other Monitoring Possibilities: It will be appreciated that—with so much information available to the microcomputer, either directly, or by calculation—a set of indicators may be included, in more expensive versions, so that the user can monitor the state of the cycle, or any one of a number of parameters, including, but not limited to, initial bread thickness and colour. In the case of an early rejection, LEDs may be illuminated (using storage capacitors, so that they stay illuminated after the power is cut) to indicate which condition caused the eject sequence.

In all versions of the invention, an alternative elapsed-time controller may be included, so that very dark bread can be time-cooked, or items warmed above the bread slots.

Extended Toaster Control: In a system configured for use in a multi-slot toaster the microcontroller could allow for several surfaces to be monitored.

The attached drawings show specific exemplifications of two of the aspects which are used in association with the invention.

In these drawings:

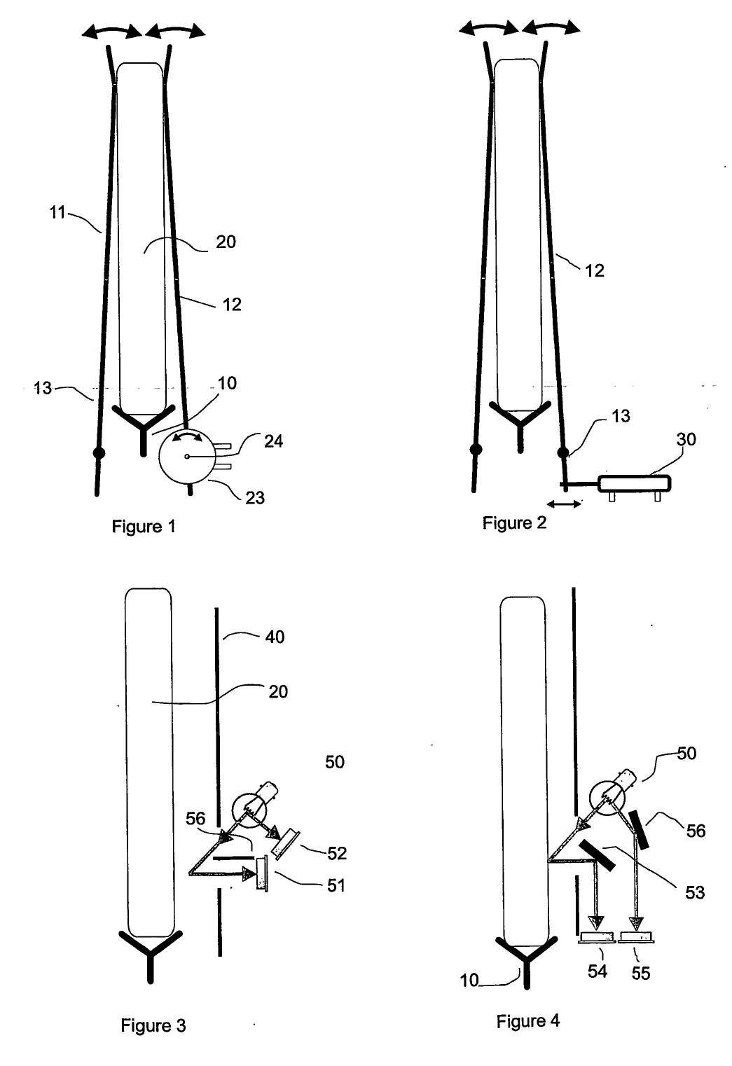

FIG. 1 shows a first method for detecting the position of the bread in relation to the optical system;

FIG. 2 shows a second method of doing this;

FIG. 3 shows a first method for illuminating the bread and for detecting the light reflected from the bread surface and for monitoring the intensity of the illuminator using two photocells; and

FIG. 4 shows a second method of doing this.

Referring to the Figures, the bread carriage 10 is shown in each of these.

In FIGS. 1 and 2 we show, at 11 and 12, the two sides of the self-centring rack for the bread to be toasted 20 each of which are mounted about a pivot shown generally at 13 and the arrangement, which is quite conventional, is that the racks move inwardly until they contact the bread as the bread carriage is lowered.

In this way, the slice of bread is spaced centrally between the toaster elements, which are not shown in FIGS. 1 and 2.

Referring to FIG. 1, there is a rotary potentiometer 23 which has its pivot 24 coaxial with the pivot 13 for one of the self-centring racks and, as such, the resistance of the potentiometer is directly dependent on the position of the rack.

In FIG. 2, rather than having a rotary potentiometer, I provide a linear potentiometer 30 which is connected to one of the racks 12 at a spacing below the pivot 13 so that, once again, as the rack moves outwardly and inwardly the resistance of the potentiometer is varied.

This provides an accurate indication of the thickness of the bread and its spacing from the illuminator.

FIGS. 3 and 4 show two methods of ascertaining the colour of the bread surface.

Referring to FIG. 3, I provide an illuminator 50 which is shown as an incandescent globe but which would normally be located in a protective casing and one portion of the light is directed towards the surface of the bread and, from this, there is reflection and, as shown, the reflected light impinges upon a photocell 51.

This photocell is protected by a shield 56 from receiving light directly from the illuminator.

A second photocell 52 is in direct line with the illuminator and we thus have two outputs from the illuminator and the second of these, received by photocell 52, provides a factor which enables compensation for changes in the output from the illuminator, either over time or because of, say, changes in the supply of voltage, and this can be used to provide a compensating factor for the output of the photocell 51.

The arrangement of FIG. 4 is not dissimilar except, in this case, the illuminator reflecting from the bread strikes a mirror 53 which deflects the reflected light and, in this case, the two photocells 54 and 55 can be mounted closely adjacent and parallel.

It will be appreciated that the paths between the illuminator and the two photocells do not have to be of the same length as it is the relative changes which is important, not a direct comparison between the two.

I prefer to locate the illuminator, the photocells and the mirror or mirrors, if one is used, or the shield 56 in a single modular unit which can also incorporate the microprocessor and to which the various controls of the toaster are connected which module can be readily replaced should this be necessary during the life of the toaster.

The module could be provided with a multi-pin connector to permit this to be done.

One particular form of program which can be used to control the operation of the toaster is set out as follows:

1 There is a delay of a few cycles (each program cycle lasts about one second) to allow the lamp to reach full power and the electronics to settle down.

2 The greyscale of the bread “BREADGREY” is then detected, and the resulting digital figure is used to implement another controlled delay. This second delay allows for the settling down of the bread, the variable factor being related to the bread's density. White bread is quite light in texture and requires less time for any moisture that might affect the optical system to come to the surface, so the settling down period for white bread will be short. But darker breads are usually quite dense, and require a longer settling down period to ensure that any beads of moisture have dried out, and that the next stage of the program will not be affected by false readings. The trick is to make this settling period long enough for the reflected light readings to stabilise, but not so long that the bread starts to go brown.

3 Following this variable settling down period, the digital greyscale factor for the bread is read and retained in the program as a digital parameter: “STARTGREY”.

4 Because brown breads require less greyscale increment to be toasted to the equivalent greyscale density as that of a piece of white bread, the variable, INCREMENT, is obtained from a formula that takes into account the starting colour of the bread, as well as the parameter “USER”, which is the user's selection of how dark they want the bread to become. A fixed figure “FACTOR” is used to control the slope of the increment curve. One formula for INCREMENT is as follows:

INCREMENT=(FACTOR×USER)/STARTGREY

Two examples:

a) A piece of white bread has a STARTGREY figure of 20; the USER setting is 30 and the fixed FACTOR is 15. The greyscale INCREMENT will be: 22.5

b) A piece of brown bread has a STARTGREY figure of 50; the USER setting is 30 and the fixed FACTOR is 15. The greyscale INCREMENT will be: 9

When INCREMENT is plotted with different values of STARTGREY, the results form an exponential curve, the slope of which can be varied by raising or lowering the variable, FACTOR. This variable would be a factory pre-set, and could take into account the prevailing bread types of the various markets in which the toasters would be sold.

Finally, STARTGREY is added to INCREMENT, the result being the greyscale value of the bread where the toasting sequence should be terminated. In the above examples, the target greyscale (when the toasting would stop) would be 42.5 and 59, respectively.

One very positive result of using a greyscale increment, instead of a fixed greyscale target, is that the distance detecting requirement need not be excessively accurate, thereby allowing lower manufacturing tolerances.

Whilst in the foregoing I have described the measurement of the spacing between the bread and the optical system as being achieved mechanically, as by the provision of the potentiometers 23, 30. This can be done in any other way. For example, it is possible to measure this spacing by way of an independent probe or an electronic arrangement such as by using sonar, infra red or light to be reflected from the surface and measuring the time for the radiation to travel from a radiation source to an appropriate sensor.

Toasting and Grilling Ovens: In such appliances the distance from the optical system to the item to be cooked may not easily be calculated automatically, without an elaborate probe system, therefore the user may be asked to estimate the distance, and then initiate a sequence to fine tune this parameter.

To aid this distance measurement, I propose the placing of a vertical linear scale on the back wall of the oven, and a corresponding scale on the glass door. By sighting through the scale on the glass door, across the food to be cooked, toward the scale on the oven's interior, a reasonably accurate estimate for the distance between the optical system and food can be made.

An alternative cooking system may give superior results, wherein the user does not select an actual colour that the cooked food has to match, but so many browning increments, as determined from a chart or guide, first selecting what they estimate the starting colour to be.

In such an embodiment, the user's determination of the present colour density may be assisted by the use of a white card, placed near the surface of the food to be cooked. With this card in position, pressing a control marked “White Balance” or the like, would cause the microcomputer to calculate the distance to the optical system, using an internal set of parameters. From this calculation, the starting colour could then be fairly accurately calculated.

In such appliances, it would also be possible to program the microcomputer to take average readings. For example, when a chicken is being roasted on a rotisserie the surface being monitored will move closer and further away from the optical system, while some areas will become darker than others, but the program would allow for an average darkening, rather than the darkening of just one portion. Even momentary peaks in the reflected light readings, caused by glistening fat, could be allowed for.

Whilst I have described herein specific embodiments of the invention, it is envisaged that other embodiments of the invention will exhibit any number of and any combination of the features previously described, and it is to be understood that variations and modifications in this application can be made without departing from the spirit and scope thereof.

1-18. (canceled)

19. An optical-color control system for browning products being cooked, comprising:
means for ascertaining an initial color of a product;
means for providing an indication of a required completion color of the product;
means for ascertaining when the product reaches the required completion color; and,
means for preventing further coloring, or browning, when the required completion color is reached.

20. The optical-color control system for browning products being cooked according to claim 19, wherein said means for ascertaining an initial color of the product and said means for ascertaining when the product reaches the required completion color are performed by an illuminator directed onto the product and a photocell for detecting brightness of a reflection of the illuminator.

21. The optical-color control system for browning products being cooked according to claim 19, wherein said means for ascertaining an initial color of the product and said means for ascertaining when the product reaches the required completion color are performed by an illuminator directed onto the product and two photocells, with a first photocell of said two photocells ascertaining a degree of reflection from the product and a second photocell of said two photocells directly impinged by light from said illuminator for compensating for variations of intensity of said illuminator.

22. The optical-color control system for browning products being cooked according to claim 19, wherein said means for ascertaining an initial color of the product and said means for ascertaining when the product reaches the required completion color are performed by an illuminator directed onto the product and a photocell for detecting brightness of a reflection of the illuminator, wherein a distance of the product from said illuminator is ascertained for providing an indication of the initial color adjusted for position of the product for permitting calculation of a required intensity of reflection when the product reaches the required completion color.

23. The optical-color control system for browning products being cooked according to claim 22, further comprising means for ascertaining the distance of the product from the illuminator for providing an indication of the initial color adjusted for the position of the product.

24. The optical-color control system for browning products being cooked according to claim 23, wherein said means for ascertaining the distance of the product from the illuminator for providing an indication of the initial color adjusted for the position of the product includes a self-centering rack with a potentiometer having a resistance that varies with variation of position of said self-centering rack.

25. The optical-color control system for browning products being cooked according to claim 19, wherein said means for ascertaining an initial color of the product and said means for ascertaining when the product reaches the required completion color are performed by an illuminator directed onto the product and a photocell for detecting brightness of a reflection of the illuminator, wherein a distance of the product from said photocell is ascertained for providing an indication of the initial color adjusted for position of the product for permitting calculation of a required intensity of reflection when the product reaches the required completion color.

26. The optical-color control system for browning products being cooked according to claim 25, further comprising means for ascertaining the distance of the product from the photocell for providing an indication of the initial color adjusted for the position of the product.

27. The optical-color control system for browning products being cooked according to claim 26, wherein said means for ascertaining the distance of the product from the photocell for providing an indication of the initial color adjusted for the position of the product includes a self-centering rack with a potentiometer having a resistance that varies with variation of position of said self-centering rack.

28. The optical-color control system for browning products being cooked according to claim 19, wherein said means for providing an indication of a required completion color of the product is a color or grey scale corresponding to the required completion color and is adjustable for providing the required completion color.

29. The optical-color control system for browning products being cooked according to claim 28, further comprising means for adjusting the required completion color-by a user.

30. The optical-color control system for browning products being cooked according to claim 19, further comprising means for defrosting the product, when frozen, before utilizing said means for ascertaining an initial color of the product.

31. The optical-color control system for browning products being cooked according to claim 30, wherein said means for defrosting is based upon a passage of time.

32. The optical-color control system for browning products being cooked according to claim 19, wherein said means for preventing further coloring, or browning, when the required completion color is reached includes means for isolating means for cooking the product from a power source for said means for cooking.

33. The optical-color control system for browning products being cooked according to claim 19, further comprising means for cooking the product for coloring, or browning, the product.

34. The optical-color control system for browning products being cooked according to claim 33, wherein said means for cooking the product is a toaster.

35. The optical-color control system for browning products being cooked according to claim 34, further comprising a carriage for delivering toast from said toaster.

36. A method for controlling browning of a product being cooked via an optical color control system, said method comprising the steps of:
ascertaining an initial color of a product to be cooked;
providing an indication of a required completion color of the product;
cooking the product thereby coloring, or browning, the product;
ascertaining when the product reaches the required completion color; and,
preventing further coloring, or browning, when the required completion color is reached.

37. A method for controlling browning of a product being cooked via an optical color control system, said method comprising the steps of:
detecting an initial color of a product to be cooked;
obtaining a color value variably dependent on color for modifying the initial color of the product;
selecting a required completion color of the product and attributing a color value for the required completion color;
cooking the product and thereby changing the initial color of the product;
ascertaining product color and the color value during said cooking step for determining when the color value reaches the color value attributed with the required completion color; and,
ceasing cooking when the color value reaches the color value for the required completion color.

38. A method for controlling browning of a product being cooked via an optical color control system according to claim 37, wherein said steps of obtaining a color value variably dependent on color for modifying the initial color of the product and for ceasing cooking when the color value reaches the color value for the required completion color are in a digital form obtained from an output of a photocell.

39. A method for controlling browning of a product being cooked via an optical color control system according to claim 37, wherein said step of cooking the product and thereby changing the initial color of the product is carried out utilizing a toaster.
